(19) United States
(12) Patent Application Publication
(10) Pub. No.: US 2008/0105161 A1
(43) Pub. Date: May 8, 2008

(54) ACTIVE ENERGY BEAM-CURABLE INK FOR SCREEN PRINTING

(75) Inventors: Keisuke Asada, Shibata-gun (JP); Fuchio Takeda, Shibata-gun (JP); Masahiro Narita, Shibata-gun (JP); Koji Nagai, Shibata-gun (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Tohoku Ricoh Co.,Ltd., Shibata-gun (JP)

(21) Appl. No.: 11/850,288

(22) Filed: Sep. 5, 2007

(30) Foreign Application Priority Data
Nov. 2, 2006 (JP) 2006-298810
Jun. 6, 2007 (JP) 2007-151006

(51) Int. Cl. C09D 11/02

(52) U.S. Cl. 106/31.13

(57) ABSTRACT

To provide an active energy beam-curable ink for screen printing, having at least monomer components and a polymerization initiator, wherein the polymerization initiator has an absorbance in terms of the concentration thereof of 100 or less at 365 nm.

### BACKGROUND OF THE INVENTION

1. Field of the Invention

The present invention relates to an active energy beam-curable ink used for screen printing where a screen printing master containing at least a film is used. And the present invention particularly relates to an active energy beam-curable ink which can prevent the screen printing master from being fixed to a printing member when the ink is left on the screen printing master.

2. Description of the Related Art

Conventionally, emulsion inks have been used in screen printing, where a screen printing master having holes punched by thermal digital platemaking is used and ink passes through the holes for forming images. However, the emulsion inks are slow to dry, and thus, when sheets of paper covered with a large portion of solid images are placed one upon another, the emulsion inks cause offsets, or transferring of ink from neighboring sheets, resulting in smears on the printed sheets/images.

In view of the foregoing, active energy beam-curable inks have been replacing the conventional emulsion inks. The active energy beam-curable inks are cured instantly with ultraviolet irradiation. Thus, the active energy beam-curable inks are advantageous in, as they dry faster than commonly used W/O (water-in-oil) type emulsion inks, preventing offsets.

Many proposals have been made regarding such active energy beam-curable inks for screen printing. For example, an active energy beam-curable ink suggested in an Example in Japanese Patent Application Laid-Open (JP-A) No. 2002-30238 contains 3% by mass of 2-benzyl-2-dimethylamino-1-(4-morphorinophenyl)-butanone-1 (trade name: IRGACURE 369, manufactured by Ciba Specialty Chemicals K.K.) as a polymerization initiator. That disclosed polymerization initiator absorbs long wavelength light, has reactivity with light having a wavelength of 365 nm and is excellent in curing property.

In the disclosed technique, however, a screen printing master for forming images is rolled up around a printing member, or a drum, which is equipped in a printer, and ink is provided between the printing member and screen printing master. Thus, when the ink is left on the screen printing master, monomer components contained in the ink move into non-image portions of the screen printing master by capillary attraction, and when they are exposed to light such as sunlight and fluorescent light, the polymerization initiator hardens the monomer components. This hardening causes fixation between the screen printing master and the printing member, which would result in causing problems when separating the screen printing master from the printing member.

### BRIEF SUMMARY OF THE INVENTION

An object of the present invention is to solve the aforementioned problems in the art and to achieve the following objects. That is, to provide an active energy beam-curable ink for screen printing, which is used for screen printing where a screen printing master containing at least a film is used, which can prevent the screen printing master from being fixed to a printing member, and which has an excellent curing property.

The means for solving the problems are as follows:

<1>. An active energy beam-curable ink for screen printing, having at least monomer components and a polymerization initiator, wherein the polymerization initiator has an absorbance calculated from the concentration thereof at 365 nm of 100 or less.

In the active energy beam-curable ink for screen printing according to <1>, a film contained in a screen printing master has a higher optical transparency at a longer wavelength. Thus, by adjusting the absorbance of the polymerization initiator at a low level at high optical transparency regions, or more specifically by adjusting the absorbance calculated from the concentration of the polymerization initiator at 365 nm at 100 or less, curing reactions of the polymerization initiator can be suppressed, and it is possible to prevent fixation between the screen printing master and a printing member and problems on separating the master from the member, caused by the fixation.

<2>. The active energy beam-curable ink according to <1>, wherein the absorbance at 365 nm is 10 or less.

<3>. The active energy beam-curable ink according to <1>, wherein the absorbance at either 254 nm or 313 nm is 1,600 or more.

<4>. The active energy beam-curable ink according to <3>, wherein the absorbance at 254 nm is 1,600 or more.

In the active energy beam-curable ink according to one of <3> and <4>, by adjusting the absorbance at either 254 nm or 313 nm at 1,600 or more and, particularly, at 254 nm at 1,600 or more, the reaction efficiency of the polymerization initiator can be increased, and thereby monomer components of the ink forming images can be cured more quickly.

<5>. The active energy beam-curable ink according to <1>, which is used for screen printing where a screen printing master containing at least a film is used.

In the active energy beam-curable ink for screen printing according to <5>, at least a film is contained in a screen printing master, and the film has a higher optical transparency at a longer wavelength. Thus, by adjusting the absorbance of the polymerization initiator at a low level at high optical transparency regions, curing reactions of the polymerization initiator can be suppressed, and it is possible to prevent fixation between the screen printing master and a printing member and problems on separating the master from the member, caused by the fixation.

<6>. The active energy beam-curable ink according to <5>, wherein the film is a polyethylene terephthalate (PET) film.

In the active energy beam-curable ink for screen printing according to <6>, the polyethylene terephthalate (PET) film can prevent transmittance of light having a wavelength of 313 nm or shorter, and thus it is possible to prevent fixation between a screen printing master and a printing member and problems on separating the master from the member, caused by the fixation.

According to the present invention, it is possible to solve conventional problems and to provide an active energy beam-curable ink, which is used for screen printing where a screen printing master containing at least a film is used, which can prevent the screen printing master from being fixed to a printing member, and which has an excellent curing property.

### BRIEF DESCRIPTION OF THE SEVERAL VIEWS OF THE DRAWING

FIG. 1 is a graph showing permeation characteristics of polypropylene (PP) and polyethylene terephthalate (PET) films in the ultraviolet region.

### DETAILED DESCRIPTION OF THE INVENTION

The active energy beam-curable ink (hereinafter may called ink) of the present invention, used for screen printing, contains at least a monomer component and a polymerization initiator, and contains a colorant, a dispersant and an extender pigment. It further contains other components in accordance with necessity.

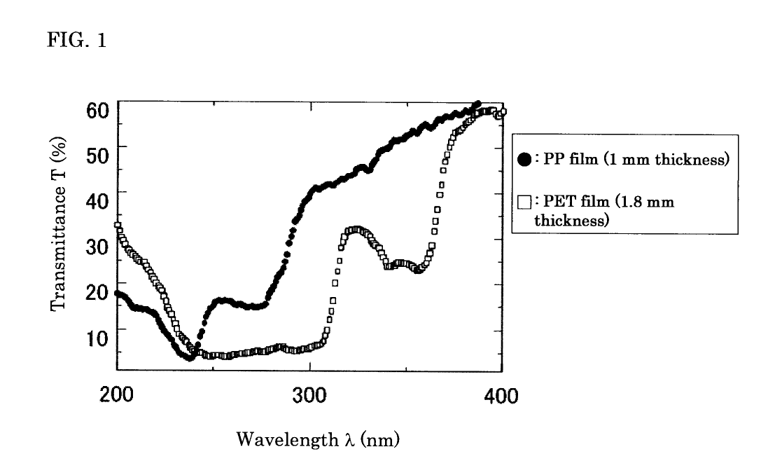

In the active energy beam-curable ink, the polymerization initiator has an absorbance calculated from the concentration thereof at 365 nm of 100 or less. It is preferably 60 or less, more preferably 10 or less, further preferably in the range of from 3 to 10, and most preferably 0. By adjusting the absorbance at those ranges, it is possible to prevent fixation between the screen printing master and a printing member and problems on separating the screen printing master from the printing member, caused by the fixation. As shown in FIG. 1, the film used in the screen printing master has a higher optical transparency at a longer wavelength. Thus, it is considered that, by adjusting the absorbance of the polymerization initiator at a low level at high optical transparency regions, curing reactions of the polymerization initiator can be suppressed. In particular, when a polyethylene terephthalate (PET) film is used in the screen printing master, fixation of the screen printing master on the printing member can be prevented with a higher effectiveness. This is because, as shown in FIG. 1, PET films can prevent much transmittance of light having a wavelength of 313 nm or shorter, compared with PP films.

In the ink, the absorbance at 254 nm or 313 nm is preferably 1,600 or higher, and more preferably 2,500 or higher. It is further preferably in the range of 3,000 to 8,000. Additionally, the ink preferably has an absorbance at 254 nm of 1,600 or higher. By adjusting the absorbance at those ranges, the reaction efficiency of the polymerization initiator can be improved, and thereby monomer components of the ink forming images can be cured more quickly.

The absorbance in terms of the concentration (mass %) of the polymerization initiator is obtained by the following equation 1 with the absorption coefficient of the polymerization initiator in methanol.

A=ε·[I] <Equation 1>

Where A represents the absorbance, ε represents the absorption coefficient (g/g-cm), and [I] represents the concentration (mass %) of the polymerization initiator in ink.

The absorption coefficient of the polymerization initiator in methanol is obtained by measuring the absorbance per 1 cm in a prepared polymerization initiator-methanol solution at different wavelengths, using a quartz cell having a path length of 1 cm and FastevertS-2400 (a spectrometer manufactured by Soma Optics, Ltd.). The absorption coefficients (g/g-cm) of the polymerization initiator at the wavelengths is obtained with the thus obtained absorbances and the concentrations of the polymerization initiator. Deuterium/halogen lamps can be used as light sources.

As described above, the active energy beam-curable ink of the present invention, used for screen printing, contains at least a monomer component and a polymerization initiator, and contains a colorant, a dispersant and an extender pigment. It further contains other component(s) in accordance with necessity.

The ink preferably contains no water. When water is contained in, the absorbance of the ink, calculated from the concentration of the polymerization initiator, may differ from that of an ink containing no water, because water absorbs ultraviolet rays.

As used herein, the term “active energy beam cure” or “active energy beam curable” means that monomer components undergo polymerization by irradiation with an active energy beam and harden. The state of the cured monomer components can be confirmed by, for example, touching ink after exposed to active energy beam irradiation.

The active energy beam may be, for example, an electron beam or ultraviolet rays.

A known lamp used for ultraviolet ray hardening, including high pressure-mercury lamps and metal halide lamps, may be used as a light source for ultraviolet ray irradiation; however, as such lamps emit light having a wavelength of 365 nm, it is preferred that a mercury amalgam lamp or an excimer lamp be used.

The ink of the present invention may be made of a material curable by radical polymerization or a material curable by cationic polymerization.

### —Polymerization Initiator—

The polymerization initiator is not particularly limited and can be appropriately selected according to the purpose, provided that the polymerization initiator has an absorbance calculated from its concentration at 365 nm of 100 or less. Examples of the polymerization initiators include radical polymerization initiators such as photoclearable initiators and proton abstracting initiators. Examples of such initiators include benzophenone, acetophenone, 4,4′-bisdiethylamino benzophenone, benzoin and benzoin ethyl ether. They may be used alone or in combination.

The polymerization initiators may be selected from commercial available products such as IRGACURE series (2959, 651, 127, 184, 907, 369, 379 and 819) and DAROCUR series (1173 and TPO) manufactured by Ciba Specialty Chemicals K.K.; and KAYACURE DETX-S, KAYACURE-ITX, benzophenone, acetophenone, 4,4′-bis(diethylamino)benzophenone, benzoin and benzoin ethyl ether manufactured by Nippon Kayaku Co., Ltd.

Of those products, IRGACURE184, 651, 2959, 907; DAROCUR1173 (all manufactured by Ciba Specialty Chemicals K.K.) or KAYACURE DETX-S (manufactured by Nippon Kayaku Co., Ltd.) are/is particularly preferably used in combination with a polymerization accelerator.

The content of the polymerization initiator is not particularly limited and can be set at a suitable level according to the purpose, while it is preferably in the range of 1% by mass to 25% by mass, more preferably 1% by mass to 10% by mass, and further preferably 3% by mass to 8% by mass based on the total mass of the ink. When the content is less than 1% by mass, a sufficient amount of radicals needed for polymerization of the monomer components may not be supplied, preventing sufficient effectiveness of the polymerization initiator to be obtained. And when it is more than 25% by mass, the polymerization initiator absorbs light, reducing the amount of light delivered into inside ink and causing defective hardening in painted ink layers.

The polymerization initiator can be used in combination with sensitizers or polymerization accelerators. The sensitizers are not particularly limited and can be appropriately selected according to the purpose. Examples thereof include aliphatic amines and/or aromatic amines such as n-butylamine, triethylamine and p-dimethylamine ethyl benzoate. More specific examples of such sensitizers include DAROCUREDB and DAROCUREHA (manufactured by Ciba Specialty Chemicals K.K.); and KAYACUREEPA and KAYACUREDMBI (manufactured by Nippon Kayaku Co., Ltd.).

### —Monomer Components—

The monomer components are not particularly limited and can be appropriately selected according to the purpose. It can be selected from, for example, monomers or oligomers of any one of polyols urethanes, epoxies and polyesters modified with (meta) acrylic acid.

The above-stated term “oligomer” refers to polymers polymerized with monomers, having a degree of polymerization in the range of about from 2 to 20, and having one or more acryloyl groups or one or more methacryloyl groups.

The above-stated term “(meta) acrylic acid”, along with other similar terms, collectively refers to acrylic acid and mixtures of methacrylic acid.

Examples of the above-stated monomers include monofunctional and polyfunctional (meta) acrylate monomers. Examples of the acrylate monomer include: dicyclo-pentell ethylacrylate; isobonyl acrylate; acrylate modified phenol ethylene oxide; tripropylene glycol diacrylate; caprolactone modified neopentylglycol hydroxypivalate ester; 1,6-hexanediol diacrylate; bisphenol A diglycidyl ether diacrylate; triethylene glycol diacrylate; tetraethylene glycol diacrylate; polyethylene glycol diacrylate (where the number of ethylene oxide units is in the range of 5 to 14; trimethylolpropane triacrylate; pentaerythritol triacrylate; propylene oxide modified glycerol triacrylate; ethylene oxide (EO) modified trimethylolpropane triacrylate (where EO is in the range of 1 to 20); propylene oxide (PO) modified trimethylolpropane triacrylate (where PO is in the range of 1 to 6); pentaerythrito tetraacrylate; ditrimethylolpropane tetra acrylate; pentaerythritol ethoxy tetra acrylate; dipentaerythritol pentaacrylate; dipentaerythritol hexaacrylate; 1,4-butandiol dimethacrylate; hexanediol dimethacrylate; ethylene glycol dimethacrylate; triethylene glycol dimethacrylate; tetraethylene glycol dimethacrylate; polyethylene glycol dimethacrylate (where the number of ethylene oxide units is in the range of 5 to 14; neopentyl glycol dimethacrylate; trimethylolpropanetrimethacrylate; caprolactone modified di-pentaerythritol hexaacrylate; caprolactone modified trimethylolpropane triacrylate; pentaerythritol tetra caprolactonate tetraacrylate; ditrimethylolpropane tetra caprolactonate tetraacrylate; ε-caprolactone modified tris(acryloxyethyl)isocyanurate; -carboxy-polycaprolactone (n=2) monoacrylate; and caprolactone acrylate.

Examples of the oligomer include epoxy acrylates, epoxidized oil acrylates, urethane acrylates, unsaturated polyesters, polyester acrylates and vinyl acrylates.

They may be used alone or in combination Of those polymers, those modified with caprolactone are preferably used in terms of safety. Caprolactone modified hydroxypivalic acid neopentylglycol ester and caprolactone modified di-pentaerythritol hexaacrylate are particularly preferable.

For minimizing changes in viscosity of the monomer components against temperature, the viscosity is preferably 2,000 mPa·s or lower, more preferably 800 mPa·s or lower, and further preferably 400 mPa·s or lower at 25° C. In this regard, however, the viscosity of the other monomer components is preferably 20 mPa·s or higher and more preferably 100 mPa·s or higher at 25° C. for preventing image defects caused by excessive flowability of ink.

The added amount of the colorant is not particularly limited, and can be set at a suitable level in accordance with the purpose, while it is preferably in the range of 15% by mass to 95% by mass based on the total mass of the ink. The added amount is more preferably in the range of 50% by mass to 85% by mass. When the added amount is less than 15% by mass, cured-ink layers may not sufficient strength, and when more than 95% by mass, a sufficient yield value of the ink may not be obtained.

### —Colorant—

The above-stated colorant is not particularly limited, and can be appropriately selected according to the purpose. Examples thereof include known insoluble colorants of various colors, including pigments, dyes and disperse dyes. The ink may not contain a colorant to be used for overprinting.

Examples of the colorant include carbon blacks such as acetylene black, channel black and furnace black; metal powders such as an aluminum powder and bronze powder; inorganic pigments such as red oxides, yellow lead, ultramarine blue, chromium oxides and titanium oxides; azo pigments such as insoluble azo pigments, azolake pigments and condensed azo pigments; phthalocyanine pigments such as metal-free phthalocyanine pigment and copper phthalocyanine pigment; polycondensed pigments such as anthraquinone dyes, quinacridon dyes, isoindolinone dyes, isoindoline dyes, dioxadin dyes, threne dyes, perylene dyes, perynone dyes, thioindigo dyes, quinophthalone dyes and metallic complexes; organic pigments such as lakes of acid or basic dyes; oil-soluble dyes such as diazo dyes and anthraquinone dyes; and fluorescent pigments.

The above-stated fluorescent pigment is preferably a synthetic resin solid solution type which can be produced by, for example, mass-polymerizing a synthetic resin, dying the resin or dissolving fluorescent dyes of various colors into the resin to obtain a colored mass resin during or after the polymerization, and crushing the thus obtained resin into fine articles. Examples of the synthetic resin into which the dyes are added include melamine resin, urea resin, sulfonamides resin, alkyd resin and polyvinylchloride resin.

When such carbon blacks are used, one having a pH in the range of from 6 to 10 may be added, or two or more carbon blacks each having a different pH may be used in combination.

The above-stated colorant may be selected from commercial available products. Examples thereof include MA-100, MA-100S, MA-7, MA-70, MA-77, MA-11, #40 and #44 (all manufactured by Mitsubishi Chemical Corporation); Raven1100, Raven1080, Raven1255, Raven760 and Raven410 (all manufactured by Columbia Carbon Company); and MOGUL-L, MOGUL-E and PEARLS-E (all manufactured by CABOT Corporation). These may be used alone or in combination.

The colorant exists in the ink in a dispersed state. The average particle diameter of the dispersed colorant in the ink is not particularly limited and can be a suitable size according to the purpose, while it is preferably in the range of 0.1 μm to 10 μm and more preferably 0.1 μm to 1.0 μm. When the average particle diameter is less than 0.1 μm, desired image density may not be obtained as pigments infiltrate into paper immediately after the ink is placed on paper, and when more than 10 μm, stability of the ink may be degraded.

The added amount of the colorant is not particularly limited, and can be set at a suitable level in accordance with the purpose, while it is preferably in the range of 2% by mass to 15% by mass based on the total mass of the ink.

### —Extender Pigment—

Examples of the extender pigments are not particularly limited and can be appropriately selected according to the purpose. Examples thereof include inorganic particulates such as china clays, silicas, talcs, clays, calcium carbonates, organic clays, barium sulfates, titanium oxides, alumina whites, diatom soil, kaolin, mica and aluminum hydroxides; organic particulates such as polyacrylate esters, polyurethanes, polyesters, polyethylenes, polypropylene, polyvinylchloride, polyvinylidene chloride, polystyrenes, poly siloxane, phenolic resin and epoxy resin; and fine particles of copolymers of these compounds.

The extender pigments may be selected from commercial available products. Examples of such products include AEROSIL series (including 50, 90G, 130, 200, 300, 380, TT600, COK84 and R972) manufactured by NIPPON AEROSIL CO., LTD.; HAKUENKA TDD and HAKUENKA 0 manufactured by Shiraishi Kogyo Kaisha, Ltd.; TIXOGEL series (including VP, DS, GB, VG, EZ-100, MP-100, MP-200, MPI and MPG) and OPTICEL manufactured by SUD-CHEMIE CATALYSTS JAPAN, INC.; Garamite series (1958, 1210, 2578, ClaytoneGR, ClaytoneHT, and ClaytonePS3) manufactured by Southern Clay Products Corporation; and SG2000 manufactured by NIPPON TALC Co., Ltd.) They may be used alone or in combination.

The content of the extender pigment is not particularly limited, and can be set at a suitable level according to the purpose, while it is preferably in the range of 0.1% by mass to 50% by mass, more preferably 1% by mass to 15% by mass, and further preferably 2% by mass to 5% by mass based on the total mass of the ink.

### —Dispersant—

The dispersant is a component with a function of dispersing colorant.

The dispersants are not particularly limited and can be appropriately selected according to the purpose. They can be selected from, for example, nonionic surfactants such as sorbitan fatty acid esters (such as sorbitansesquioleate), polyglyceryl fatty acid esters (such as hexaglycerin polyricinoleate), polyoxyethylene, glycerin fatty acid ester, polyoxyethylene sorbitan fatty acid ester, polyoxyethylene alkyl ether, polyoxyethylene alkylamine and polyoxyethylene fatty acid amide; high molecular compounds of alkylamines; compounds of aluminum chelates; copolymerized high molecular compounds of styrene—maleic anhydrides; high molecular compounds of polycarboxylic acid esters; aliphatic polyvalent carboxylic acids; amine salts of high molecular polyesters; ester anionic surfactants; long-chain amine salts of high molecular weight polycarboxylic acids; salt of long-chain polyamino amides and polyacid polyesters; compounds of polyamides; phosphoric acid ester surfactants; salt of alkyl sulfo-carboxylic acids; sulfonates; α-olefin sulfonates; dioctyl sulfosuccinate salts; polyethyleneimine; alkanolamides salts; and resins, such as alkyd resins, having function of dispersing insoluble colorants. They may be used alone or in combination.

The dispersants may be selected from commercial available products such as SOLUSPHASE series (including S3000, S5000, S9000, S13240, S13940, S16000, S17000, S20000, S24000, S26000, S27000, S28000, S31845, S31850, S32000, S32550, S33000, S34750, S36000, S39000, S41090 and S53095) manufactured by Lubrizol Japan Ltd.; PLANE-ACT AL-M and AJISPER series (including PB711, PM821, PB821, PB811, PN411 and PA11) manufactured by Ajinomoto Fine-Techno Co., Inc.; and 6220, 6225, 6230 and 5244 manufactured by EFKA Additives.

The added amount of the dispersant is not particularly limited and can be set at a suitable level in accordance with the purpose, while it is preferably 40% by mass or less and more preferably in the range of 2% by mass to 35% by mass based on the total mass of contained colorants and extender pigments.

### <Other Components>

The other components in the ink of the present invention are not particularly limited and can be appropriately selected according to the purpose, provided that the effectiveness of the ink of the present invention is not degraded by adding the other components. They may be selected from, for example, polymerization inhibitors and vegetable oils.

### —Polymerization Inhibitor—

The ink of the present invention may contain a polymerization inhibitor for enabling it to be stored more safely and preventing it from gelation caused by dark reactions.

The polymerization inhibitor is not particularly limited and can be appropriately selected according to the purpose. It can be selected from, for example, hydroquinone, p-benzoquinone, t-butylhydroquinone and p-methoxyphenol (MEHQ).

In general, the added amount of the polymerization inhibitors is preferably in the range of 100 ppm to 5,000 ppm and more preferably in the range of 100 ppm to 500 ppm based on the total mass of the ink.

### —Vegetable Oil—

One or more vegetable oils may be used for the ink of the present invention in accordance with necessity, provided that the curing property of the ink is not degraded by adding the oils.

The vegetable oil is not particularly limited and can be appropriately selected according to the purpose. It can be selected from, for example, bean oil, rapeseed oil, corn oil, sesame oil, tall oil, cotton seed cake oil, sunflower oil, safflower oil, walnut oil, poppy oil, linseed oil and esterified products of those oils. Examples of the esters in the esterified oils include methylesters, butylesters, isopropylesters and propylesters.

They may be used alone or in combination. Of those above-stated oils, vegetable oils having an iodine value of 100 or more, which are generally so-called drying oils or semidrying oils, are preferable for obtaining better drying characteristic of the ink after it is placed on paper. In this regard, however, vegetable oils having an iodine value of less than 100 may be used when the ink is left in a printer for a long period of time and it results in occurrences of ink fixation.

When a drying oil and/or semidrying oil having a high iodine value are used as the vegetable oil, they tend to react with oxygen existing in atmosphere, causing dryness and solidification of the oils, and, in particular, resulting in solidification of the ink in which the oils are contained. The solidification of the ink then causes clogging of a screen and reduction in printing speed/image quality. Thus, when such vegetable oil having a high iodine value (or having many unsaturated bonds) is used, it is preferable that the below-mentioned antioxidant be contained in ink for preventing oxidization of fatty acids (such as linolenic acid, linoleic acid and oleic acid) of the vegetable oil.

The added amount of the vegetable oil is not particularly limited and can be set at a suitable level according to the purpose, while it is preferably in the range of 5% by mass to 70% by mass, and more preferably 30% by mass to 50% by mass based on the total mass of the ink.

### —Antioxidant—

The above-stated antioxidant is not particularly limited and can be appropriately selected according to the purpose. Examples thereof include amine compounds such as diphenyl-phenylenediamine and isopropylphenyl-phenylenediamine; phenolic compounds such as tocopherol and dibutylmethylphenol; sulfur compounds such as mercaptomethyl-benzimidazole; dibutylhydroxytoluene; propyl gallate; and butylhydroxyanisole. Those compounds may be used alone or in combination.

The added amount of the antioxidant is not particularly limited, and it can be set at a suitable level in accordance with the purpose, while the added amount is preferably 2.0% by mass or less based on the content of the vegetable oil. It is more preferably in the range of from 0.1% by mass to 1.0% by mass based on the content of the vegetable oil.

Sufficient antioxidant effect may not be obtained when antioxidant is added in a little amount relative to the content of vegetable oil; on the other hand, when it is added at a time in an excessive amount, it may function as a pro-oxidant agent. Thus, the below-mentioned synergist should preferably be added for obtaining desired antioxidant effect for vegetable oil with a small amount of antioxidant.

### —Synergist—

The term “synergist” refers to compounds that themselves provide almost no antioxidant effect but enhances this effect when used in combination with an antioxidant. In general, the synergist is preferably acid, and more preferably is a polyfunctional compound having one or more hydroxyl groups or carboxyl groups.

The above-stated synergist is not particularly limited and can be appropriately selected from known compounds according to the purpose. Examples thereof include methionine, ascorbic acid, threonine, leucin, hydrolyzed milk proteins, vorvaline, ascorbyl palmitate, phenylalanine, cysteine, tryptophan, proline, alanine, glutaminic acid, valine, pepsin digestive fluid of pancreatic proteins, asparagine, arginine, barbiturates, asphenamine, ninhydrin, propanidine, histidine, norleucine, glycerophosphoric acid, liquid of casein hydrolyzed by trypsin, and liquid of casein hydrolyzed with hydrochloric acid. Those compounds may be used alone or in combination.

The added amount of the synergist is not particularly limited and can be set at a suitable level in accordance with the purpose, while it is preferably in the range of from 50 parts by mass to 150 parts by mass based on the total mass of the antioxidant. It is more preferably in the range of from 70 parts by mass to 120 parts by mass based on the total mass of the antioxidant.

### <Production Method for Active Energy Beam-Curable Ink for Screen Printing>

The production method for the active energy beam-curable ink of the present invention, used for screen printing, is not particularly limited and can be appropriately selected according to the purpose. For example, it can be obtained by a dispersion treatment which includes mixing necessary components by a usual process and dispersing the mixture using a dispersion machine such as a three-roll mill.

The viscosity of the ink used in screen printing systems can be adjusted at a suitable level by changing agitation conditions. The viscosity is not particularly limited, provided it is suitable to be used in screen printing and the system therefor. The viscosity is preferably in the range of 2 Pa·s to 40 Pa·s, and more preferably in the range of 10 Pa·s to 30 Pa·s when the share rate is 20/s.

Additionally, an approximate yield value of the ink, obtained by the following Casson's equation, is preferably in the range of from 40 Pa to 300 Pa for preventing curling of printed paper. It is more preferably in the range of from 60 Pa to 200 Pa. The plastic viscosity of the ink is preferably 2.0 Pa·s or lower. It is more preferably in the range of from 0.1 Pa·s to 1.0 Pa·s.

### Casson's Equation

\sqrt{τ}−\sqrt{τ₀}=\sqrt{Eta×E}

Where τ represents shear stress, τ₀ represents yield value, Eta represents plastic viscosity, and D represents shear velocity.

The active energy beam-curable ink of the present invention can be preferably used for screen printing where a screen printing master containing at least a film is used.

The screen printing master may be, for example, (1) one made of film, (2) one made of film and tissue paper, or (3) one having three or more layers including a film, a sheet of tissue paper and a porous sheet which is provided in between the film and the sheet of tissue paper.

The film is not particularly limited and can be appropriately selected according to the purpose. It is preferably selected from those having a low optical transparency. Examples of such materials include polypropylene (PP) and polyethylene terephthalate (PET) films. Of those materials, PET films are preferable as they have a characteristic that they can prevent transmittance of light having a wavelength of 313 nm or shorter, and are excellent in cost performance, perforatability and optical transparency.

Examples of above-mentioned tissue paper include those made of natural fibers, synthetic fibers or combination of natural fibers and synthetic fibers.

Examples of the above-mentioned porous sheet at least include porous resin membranes and porous fiber membranes.

### EXAMPLES

Hereinafter, with referring to Examples and Comparative Examples, the invention is explained in detail and the following Examples and Comparative Examples should not be construed as limiting the scope of this invention.

### Examples 1 to 16 and Comparative Examples 1 to 2

### Preparation of Ultraviolet Ray-Curable Ink for Screen Printing

Ultraviolet ray-curable inks for screen printing were prepared in Examples 1 to 16 and Comparative Examples 1 to 2, in accordance with the formulations shown in Tables 1 to 3. In this preparation, components—colorants, dispersants, extender pigments, monomer components (shown in Table 5) and polymerization initiators (shown in Table 4)—for each ultraviolet ray-curable ink were mixed, and then they were dispersed using a three-roll mill (manufactured by INOUE MANUFACTURING CO., LTD.) to thereby obtain the inks.

As described below, the absorbance of each ink was measured at different wavelengths. The results are shown in Tables 1 to 3.

### <Measurement of Absorbance>

The absorbance measured in terms of the concentration of the polymerization initiator was obtained using the following equation 1 in terms of the absorption coefficient (cf Table 4) of the polymerization initiator in methanol.

A=ε·[I] Equation 1

Where A represents the absorbance, ε represents the absorption coefficient (g/g-cm), and [I] represents the concentration of the polymerization initiator in ink.

To obtain the absorption coefficient of the polymerization initiator in methanol, the absorbance per 1 cm at wavelengths in a prepared polymerization initiator-methanol solution was measured using a quartz cell having a path length of 1 cm and FastevertS-2400 (a spectrometer manufactured by Soma Optics, Ltd.). The absorption coefficient (g/g-cm) of the polymerization initiator at the different wavelengths was obtained from the thus obtained absorbance and the concentration of the polymerization initiator. Deuterium/halogen lamps were used as light sources.

TABLE 1

| | | Example | | | | | | |
|---|---|---|---|---|---|---|---|---|
| | | 1 | 2 | 3 | 4 | 5 | 6 | 7 |
| Polymerization | Abbr. name (cf. | IR184 | IR184 | IR184 | IR184 | IR184 | DA1173 | DA1173 |
| initiator | Table 4) | | | | | | | |
| | Added amount | 5.00 | 7.00 | 10.00 | 13.00 | 20.00 | 7.00 | 10.00 |
| Colorant | Mogul-E | 7.00 | 7.00 | 7.00 | 7.00 | 7.00 | 7.00 | 7.00 |
| Dispersant | Solsperse33000 | 0.40 | 0.40 | 0.40 | 0.40 | 0.40 | 0.40 | 0.40 |
| Extender pigment | Aerosil200 | 4.00 | 4.00 | 4.00 | 4.00 | 4.00 | 4.00 | 4.00 |
| Monomer | Monomer A | 41.80 | 40.80 | 39.30 | 37.80 | 34.30 | 40.80 | 39.30 |
| component (cf. | Monomer B | 41.80 | 40.80 | 39.30 | 37.80 | 34.30 | 40.80 | 39.30 |
| Table 5) | | | | | | | | |
| Total (% by mass) | | 100.00 | 100.00 | 100.00 | 100.00 | 100.00 | 100.00 | 100.00 |
| Absorbance | 254 nm | 1310 | 1834 | 2620 | 3407 | 5241 | 2247 | 3211 |
| | 313 nm | 17 | 24 | 34 | 45 | 69 | 31 | 45 |
| | 365 nm | 4 | 5 | 7 | 9 | 14 | 4 | 6 |

TABLE 2

| | | Example | | | | | | |
|---|---|---|---|---|---|---|---|---|
| | | 8 | 9 | 10 | 11 | 12 | 13 | 14 |
| Polymerization | Abbr. name | IR651 | IR651 | IR651 | IR2959 | IR2959 | IR2959 | IR907 |
| initiator | (cf. Table 4) | | | | | | | |
| | Added amount | 4.00 | 6.00 | 10.00 | 8.00 | 10.00 | 21.00 | 3.00 |
| Colorant | Mogul-E | 7.00 | 7.00 | 7.00 | 7.00 | 7.00 | 7.00 | 7.00 |
| Dispersant | Solsperse33000 | 0.40 | 0.40 | 0.40 | 0.40 | 0.40 | 0.40 | 0.40 |
| Extender pigment | Aerosil200 | 4.00 | 4.00 | 4.00 | 4.00 | 4.00 | 4.00 | 4.00 |
| Monomer | Monomer A | 42.30 | 41.30 | 39.30 | 40.30 | 39.30 | 33.80 | 42.80 |
| component (cf. | Monomer B | 42.30 | 41.30 | 39.30 | 40.30 | 39.30 | 33.80 | 42.80 |
| Table 5) | | | | | | | | |
| Total (% by mass) | | 100.00 | 100.00 | 100.00 | 100.00 | 100.00 | 100.00 | 100.00 |
| Absorbance | 254 nm | 1488 | 2232 | 3719 | 1917 | 2396 | 5032 | 93 |
| | 313 nm | 23 | 34 | 57 | 162 | 203 | 426 | 1337 |
| | 365 nm | 11 | 17 | 29 | 3 | 4 | 8 | 11 |

TABLE 3

| | | | | Comparative | |
|---|---|---|---|---|---|
| | | Example | | Example | |
| | | 15 | 16 | 1 | 2 |
| Polymerization | Abbr. name | IR907 | IR907 | IR369 | IR369 |
| initiator | (cf. Table 4) | | | | |
| | Added amount | 5.00 | 10.00 | 3.00 | 10.00 |
| Colorant | Mogul-E | 7.00 | 7.00 | 7.00 | 7.00 |
| Dispersant | Solsperse33000 | 0.40 | 0.40 | 0.40 | 0.40 |
| Extender pigment | Aerosil200 | 4.00 | 4.00 | 4.00 | 4.00 |
| Monomer | Monomer A | 41.80 | 39.30 | 42.80 | 39.30 |
| component | Monomer B | 41.80 | 39.30 | 42.80 | 39.30 |
| (cf. Table 5) | | | | | |
| Total (% by mass) | | 100.00 | 100.00 | 100.00 | 100.00 |
| Absorbance | 254 nm | 155 | 311 | 177 | 590 |
| | 313 nm | 2228 | 4456 | 1150 | 3835 |
| | 365 nm | 18 | 37 | 186 | 621 |

In Tables 1 to 3, “Mogul-E” represents Mogul-E manufactured by CABOT Corporation, “Solsperse33000” represents Solsperse33000 manufactured by Lubrizol Japan Ltd., and “Aerosil200” represents Aerosil200 manufactured by NIPPON AEROSIL CO., LTD.

TABLE 4

| | | | Absorption coefficient | | |
|---|---|---|---|---|---|
| Abbr. | | | (g/g-cm in MeOH) | | |
| name | Trade name | Chemical name | 254 nm | 313 nm | 365 nm |
| IR184 | IRGACURE 184 | 1-hydroxy-cyclohexyl-phenyl-ketone | 26,204 | 344 | 70 |
| DA1173 | DAROCUR 1173 | 2-hydroxy-2-methyl-1-phenyl-propane-1-one | 32,106 | 445 | 58 |
| IR651 | IRGACURE 651 | 2,2-dimethoxy-1,2-diphenylethane-1-one | 37,193 | 571 | 285 |
| IR2959 | IRGACURE | 1-[4-(2-hydroxyethoxy)-phenyl]-2-hydroxy-2- | 23,961 | 2,029 | 39 |
| | 2959 | methyl-1-propane-1-one | | | |
| IR907 | IRGACURE 907 | 2-methyl-1-[4-(methylthio)phenyl]-2- | 3,109 | 44,564 | 369 |
| | | morpholinopropane-1-one | | | |
| IR369 | IRGACURE 369 | 2-benzil-2-dimethylamino-1-(4-morpholinophenyl)- | 5,901 | 38,347 | 6,208 |
| | | butanone-1 | | | |

All the polymerization initiators in Table 4 are manufactured by Ciba Specialty Chemicals K.K.

TABLE 5

| Abbr. name | Chemical name |
|---|---|
| Monomer A | Caprolactone modified di-pentaerythritol hexaacrylate |
| Monomer B | Caprolactone modified hydroxypivalic acid neopentylglycol |
| | ester |

Curing property of each obtained ink, as well as fixation of a screen printing master when using the ink, were evaluated as follows. The results are shown in Tables 6 to 8.

### <Fixation test of Screen Printing Master>

Ink weighing 0.5 g was uniformly spread on the tissue paper-side of the screen printing master which was 10 cm long and wide and was made of PET film and tissue paper. The tissue paper-side was placed on a glass plate, and left in the indoors for a month without light shielding. Then, the fixation of the screen printing master to the glass plate was evaluated using the following criteria.

### <Evaluation Criteria>

A: Fixation did not occur between the master and plate.

B: Partial fixation occurred between the master and plate.

C: Fixation occurred between the master and plate, while the master could be separated.

D: Fixation occurred, and the master could not be separated.

### <Image Output Test for Evaluating the Curing Property of Ink>

Images were printed using the ultraviolet ray-curable inks of Examples 1 to 16 and Comparative Examples 1 to 2 in a screen printer (SATELIO A650, manufactured by Ricoh Company, Ltd.). Then, in order to harden ink forming the printed images, the printed images were irradiated with ultraviolet rays using an ultraviolet ray irradiator containing three 400 W medium pressure mercury lamps (HOK4/120, manufactured by Philips). Then, the printed images were rubbed with a piece of cloth being wet with water to evaluate the curing property of each ink using the following criteria.

### <Evaluation Criteria>

A: Smears were not recognized on both printed image and cloth.

B: Smears were not recognized on the printed image, while cloth was little stained.

C: Slight smears were recognized on both printed image and cloth.

D: Smears were recognized on both printed image and cloth.

TABLE 6

| | Example | | | | | | | |
|---|---|---|---|---|---|---|---|---|
| | 1 | 2 | 3 | 4 | 5 | 6 | 7 | 8 |
| Curing property | C | B | A | A | A | B | A | C |
| Fixation | A | A | A | A | B | A | A | B |

TABLE 7

| | Example | | | | | | | |
|---|---|---|---|---|---|---|---|---|
| | 9 | 10 | 11 | 12 | 13 | 14 | 15 | 16 |
| Curing property | B | A | B | B | A | C | B | A |
| Fixation | B | B | A | A | A | B | B | C |

TABLE 8

Comparative
Example

| | 1 | 2 |
|---|---|---|
| Curing property | C | A |
| Fixation | D | D |

As the results shown in Tables 1 to 3 and 6 to 8 indicate, the ultraviolet ray-curable inks of Examples 1 to 16, having an absorbance calculated from the concentration of the polymerization initiators at 365 nm of 100 or less, were excellent in preventing the screen printing masters from being fixed to the printing member and had an excellent curing property compared with that of Comparative Examples 1 to 2.

The active energy beam-curable ink of the present invention, used for screen printing, can prevent a screen printing master from being fixed to a printing member and has an excellent curing property. Thus, it can be preferably used for screen printers where a screen printing master containing at least a film is used.

What is claimed is:

1. An active energy beam-curable ink for screen printing, comprising:
at least a monomer component,
and a polymerization initiator,
wherein the polymerization initiator has an absorbance calculated from the concentration thereof at 365 nm of 100 or less.

2. The active energy beam-curable ink according to claim 1, wherein the absorbance at 365 nm is 10 or less.

3. The active energy beam-curable ink according to claim 1, wherein the absorbance at either 254 nm or 313 nm is 1,600 or more.

4. The active energy beam-curable ink according to claim 3, wherein the absorbance at 254 nm is 1,600 or more.

5. The active energy beam-curable ink according to claim 1, which is used for screen printing where a screen printing master containing at least a film is used.

6. The active energy beam-curable ink according to claim 5, wherein the film is a polyethylene terephthalate (PET) film.
